(19) United States
(12) Patent Application Publication
(10) Pub. No.: US 2005/0256431 A1
(43) Pub. Date: Nov. 17, 2005

(54) Skin care pad with ultrasonic transducer

(76) Inventor: Masatoshi Masuda, Kyoto-city (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/844,304

(22) Filed: May 12, 2004

(51) Int. Cl. A61H 1/00

(52) U.S. Cl. 601/2

(57) ABSTRACT

A cosmetic device for improving skin conditions comprises: (i) a fluid-storing portion fluid-tightly storing a fluid therein comprised of a thin material, on a surface of which portion a planar contact surface adapted to contact a skin is formed; and (ii) at least one ultrasonic transducer disposed near or at the fluid-storing portion to propagate ultrasonic waves through the fluid to the skin. The fluid is fluid-tightly stored in the fluid-storing portion and is not in contact with the body. Ultrasonic waves are propagated through the fluid to a skin.

### BACKGROUND OF THE INVENTION

1. Field of the Invention

The present invention relates to a cosmetic device for achieving cosmetic effect by giving ultrasonic vibration to the skin. In particular, the present invention relates to a skin care pad provided with a ultrasonic transducer.

2. Description of the Related Art

As described in Japanese Patent Laid-open No. 2000-233009, a cosmetic device comprising a pad and an ultrasonic transducer which gives ultrasonic vibration to the pad is known. This cosmetic device is constructed so that ultrasonic waves oscillated from the ultrasonic transducer are propagated to the skin via the pad while sliding the pad on a skin surface. By using the cosmetic device in this manner, cosmetic effects including body metabolism stimulatory effect can be achieved through massaging action and deep thermal action by thermal energy effects, etc.

Additionally, as described in Japanese Patent Laid-open No. 2002-000684, a cosmetic device having a belt in which multiple probes having ultrasonic transducers built-in are disposed is also known. Because this cosmetic device can be wrapped around the body, ultrasonic waves oscillated from the ultrasonic transducer are propagated to the skin via a pad without sliding the cosmetic device on the skin surface, and the same effects as achieved by the cosmetic device described in Japanese Patent Laid-open No. 2000-233009 can be achieved.

When the above-mentioned cosmetic devices are used, a gel or a cream is applied to the skin surface or the skin-surface-contact portion of the cosmetic device to improve ultrasonic wave propagation efficiency by contacting the skin-surface-contact portion of the cosmetic device with a skin surface. Subsequently, the skin-surface-contact portion of the cosmetic device is placed onto the skin surface using light pressure and is moved along the skin surface if needed.

However, when the above-mentioned cosmetic devices are used, it is required not only to apply a gel or a cream on the skin surface or the skin-surface-contact portion of the cosmetic device, but also to wipe out the gel or the cream applied to the skin surface or the skin-surface-contact portion of the cosmetic device. Additionally, the gel or the cream applied to the skin surface or the skin-surface-contact portion of the cosmetic device may get through inside the cosmetic device and shorten the life of the cosmetic device.

The cosmetic device described in Japanese Patent Laid-open No. 2002-000684 is able to give vibration by ultrasonic waves to a broad surface of skin surface without sliding it on the skin surface. However, the cosmetic device needs to comprise many ultrasonic transducers; hence, it is difficult to reduce manufacturing costs.

The present invention has been achieved to solve the above-mentioned problems. An object of the present invention is to provide a cosmetic device which is capable of contacting a skin-surface-contact portion of the cosmetic device with a skin surface without applying a gel or a cream and which is capable of improving propagation efficiency of ultrasonic vibration onto a broad surface or a localized surface of skin surface without increasing manufacturing costs.

### SUMMARY OF THE INVENTION

In an embodiment, the present invention provides a cosmetic device for improving skin conditions comprising: (i) a fluid-storing portion fluid-tightly storing a fluid therein comprised of a thin material, on a surface of which portion a planar contact surface adapted to contact a skin of the body is formed; and (ii) at least one ultrasonic transducer disposed near or at the fluid-storing portion to propagate ultrasonic waves through the fluid to the skin. According to the above embodiment, the fluid is fluid-tightly stored in the fluid-storing portion, and is not in contact with the body. The outer surface of the planar contact surface is also not in contact with the fluid. Ultrasonic waves are propagated through the fluid to a skin. Thus, a fluid need not be applied on the skin to enhance ultrasonic wave energy, and the skin and the outer surface of the planar contact surface are in dry contact with each other, thereby increasing operability and sanitary conditions.

The present invention further includes, but is not limited to, the following embodiments:

The fluid-storing portion may be configured to form a fluid layer therein having a thickness of about 1 mm to about 10 mm, preferably in the range of about 5 mm to about 10 mm, in view of propagation efficiency (in an embodiment, about 6 mm to about 8 mm). The thin material constituting the fluid-storing portion may be made of any soft resin which preferably has affinity with the skin, does not interfere with ultrasonic wave propagation, exhibits elasticity in wide temperature ranges, and has resistance to weather, heat, and chemicals such as acids, alkaline, and alcohol. Such a material includes, but is not limited to, vinyl chloride resin, styrene base thermoplastic elastomer, and a mixture of such an elastomer and an olefin resin (e.g., PP and PE).

In the above, the fluid-storing portion may be configured to give the planar contact surface in an area of about 1 cm² to about 2,000 cm², preferably in the range of about 5 cm² to about 500 cm², depending on the target area of the body. The target area includes, but is not limited to, the face, the neck, the back, the shoulders, the arms, the thighs, the calves, the abdomen, the chest, the feet, the knees, the elbows, etc. The skin can be improved by massaging effect and thermal action effect.

The fluid may be any suitable fluid which propagates ultrasonic waves such as a gel or cream. In an embodiment, the gel or cream designed for direct application to the skin can be used. In an embodiment, the gel or cream may have a viscosity of 1,000-25,000 cP at room temperature (if it is liquid) or have a gel strength of 10-100 g/cm² at room temperature (if it is gelatinous). The gel or cream may contain water, glycerin, amino acid salts, etc.

In an embodiment, each transducer may be disposed on a surface of the fluid-storing portion opposite to the planar contact surface. In this case, ultrasonic waves are propagated through the fluid in a vertical direction. The at least one transducer may be multiple transducers, and the fluid-storing portion may be divided into multiple compartments by isolation walls, wherein each compartment corresponds to each transducer. This depends on the size of the fluid-storing portion and the size of the transducer. The isolation walls may have through holes through which the fluid passes. Additionally, in the above, the device may further comprise a controller which transmits ultrasonic wave signals to each transducer in sequence so as to prevent isolating ultrasonic energy in one spot and to cover a wide area, thereby increasing massaging and thermal effect.

In the above, when propagation of ultrasonic waves is accomplished in a vertical direction, preferably, the transducer is capable of emitting ultrasonic waves at a frequency of about 500 kHz to about 10 MHz, preferably in the range of about 1 MHz to about 5 MHz. In an embodiment, the transducer is capable of transmitting ultrasonic waves having multiple frequencies, and a frequency can be selected by a switch (e.g., 1 MHz, 1.5 MHz, 2 MHz, 3 MHz). The frequency may be selected depending on the target location and the skin conditions.

In another embodiment, each transducer may be disposed at one longitudinal end of the fluid-storing portion at an acute angle with respect to an exposed surface of the fluid stored in the fluid-storing portion to generate surface waves in the fluid. In this embodiment, ultrasonic waves are propagated in a horizontal direction, i.e., a longitudinal direction of the fluid-storing portion. The transducer and the fluid-storing portion may be configured to provide a propagation depth of about 35 mm in the fluid, so that ultrasonic waves can be propagated as surface waves through the fluid. Such surface waves are effective in treating the skin. Additionally, in this embodiment, the transducer is preferably capable of emitting ultrasonic waves at a frequency of about 40 kHz to about 1 MHz, more preferably in the range of about 60 kHz to about 200 kHz. In order to provide a propagation depth of about 35 mm, a frequency of about 80 kHz may be effective.

In the above, the device may further comprise a vibration stop layer disposed on a side opposite to the planar contact surface of the fluid-storing portion.

In still another embodiment, the present invention provides a cosmetic device for a skin comprising: (a) a fluid-storing portion storing a fluid therein and constituted by a soft pouched material, on a surface of which portion a body-contacting planar surface which can contact the body is formed; (b) at least one ultrasonic transducer having a given angle of gradient with the body-contacting surface of said fluid-storing portion, wherein an oscillating surface of said transducer is disposed facing said fluid-storing portion; and (c) a surface-wave-generating material supporting said ultrasonic transducer and having a contacting surface which contacts the edge of said fluid-storing portion, wherein said contacting surface is disposed to cross the normal line from nearly the center of said ultrasonic transducer. According to the embodiment, it becomes possible to propagate surface waves to the fluid-storing portion by vibration of the ultrasonic transducers via the surface-wave-generating material.

In the above, the center portion of the contacting surface of said surface-wave-generating material and the normal line from nearly the center of said ultrasonic transducers may be crossed. According to the embodiment, it becomes possible to propagate the surface waves to the fluid-storing portion efficiently.

Further, the contacting surface of said surface-wave-generating material may be a convex planar surface. According to the embodiment, it becomes possible to propagate the surface waves to the fluid-storing portion further efficiently.

In an embodiment, the device may further comprise a supporting material which supports said fluid-storing portion and said ultrasonic transducer from the reverse side of said body-contacting surface in said fluid-storing portion, wherein said supporting material comprises a fastening material to be used to attach said supporting material to a part of the body along with said fluid-storing portion and said ultrasonic transducer. According to the embodiment, it becomes possible to attach the cosmetic device around the body.

In yet another embodiment, the present invention provides a cosmetic device for a skin comprising: (I) a fluid-storing portion storing a fluid therein and comprising a soft pouched material, on a surface of which portion a planar contact surface which can contact the body is formed; and (II) at least one ultrasonic transducer, which are disposed on a surface on the reverse side of said contact surface. According to the embodiment, the cosmetic device is capable of contacting the skin-surface-contact portion of the cosmetic device with the skin surface without applying a gel or a cream to the skin surface or the skin-surface-contact portion of the cosmetic device, and of improving ultrasonic vibration propagation efficiency.

In an embodiment, on a surface of said fluid-storing portion, multiple ultrasonic transducers may be disposed. According to the embodiment, ultrasonic vibration can be propagated to a local surface of the body.

The device may further comprise an ultrasonic-transducer drive mechanism which vibrates said multiple ultrasonic transducers sequentially. According to the embodiment, it becomes possible to obtain cosmetic effects efficiently without giving excessive stimulation to the skin.

In another embodiment, the device may further comprise partition-walls dividing a fluid stored inside said fluid-storing portion into multiple compartments. According to the embodiment, it becomes possible to stabilize a fluid inside divided surfaces by the partition-walls 14.

Multiple pores through which said fluid can pass may be formed in said partition-walls. According to the embodiment, it becomes possible to stabilize the fluid inside the surfaces divided by the partition-walls 14.

In the aforesaid devices, they may further comprise a supporting material which supports said fluid-storing portion and said ultrasonic transducer from the reverse side of said contact surface in said fluid-storing portion and wherein said supporting material comprises a fastening material which is used for attaching the supporting material to a part of the body along with said fluid-storing portion and said ultrasonic transducer. According to the embodiment, it becomes possible to wrap the cosmetic device around the body.

For purposes of summarizing the invention and the advantages achieved over the prior art, certain objects and advantages of the invention have been described above. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention.

FIG. 1 is a plan view showing a cosmetic device according to an embodiment of the present invention.

FIG. 2 is a longitudinal cross sectional view showing an A-A cross section in FIG. 1.

FIG. 3 is a cross sectional view showing a peripheral portion of a surface-wave-generating material 60 in a cosmetic device 1 according to an embodiment of the present invention.

FIG. 4 is a front view showing a position in which the surface-wave-generating material 60 in the cosmetic device 1 according to the embodiment of the present invention supports a ultrasonic transducers 20.

FIG. 5 is a lateral view showing the ultrasonic transducers 20 and the surface-wave-generating material 60 in the cosmetic device 1 according to the embodiment of the present invention.

FIG. 6 is a front view showing a cosmetic device according to an embodiment of the present invention.

FIG. 7 is a longitudinal cross sectional view showing an A-A cross section in FIG. 6.

FIG. 8 is a backside view of a cosmetic device 1′ according to an embodiment of the present invention with the belt 50′ removed.

FIG. 9 is an explanation drawing of the cosmetic device 1′ according to another embodiment of the present invention.

FIG. 10 is a longitudinal cross sectional view showing an A-A cross section in FIG. 9.

FIG. 11 is a longitudinal cross sectional view showing the relevant part of the fluid-storing portion 10′ of the cosmetic device 1′ according to the embodiment of the present invention.

FIG. 12 is a longitudinal cross sectional showing a B-B cross section in FIG. 9.

FIG. 13 is a block diagram showing a main electrical configuration of the cosmetic device 1′ according to an embodiment of the present invention.

FIG. 14 is a time chart showing timing in which respective ultrasonic transducers of the cosmetic device 1′ according to an embodiment of the present invention vibrate.

Explanation of symbols used is as follows: 1: Cosmetic device; 10: Fluid-storing portion; 11: Body-contacting surface; 12: Backside surface; 13: Fluid; 20: Ultrasonic transducer; 21: Vibration surface; 30: Vibration-prevention layer; 50: Belt; 51: Ring material; 60: Surface-wave-generating material; 61: Contact surface (incidence plane); 62: Supporting surface; 70: Surface wave; 1′: Cosmetic device; 10′: Fluid-storing portion; 11′: Contact area; 12′: Surface: 13′: Fluid; 14′: Partition-wall; 15′: Pore; 20′: Ultrasonic transducer; 31′: Input portion; 32′: Ultrasonic-wave-generating portion; 33′: Controller; 34′: Oscillator; 35′: Ring counter; 36′: FET switch; 50′: Belt; 51′: Ring material.

### DETAILED DESCRIPTION OF THE PREFERRED EMBODIMENT

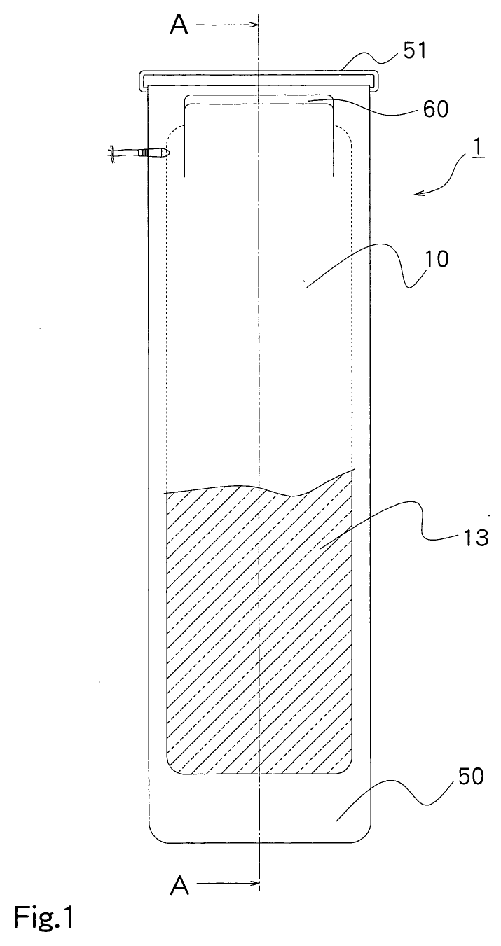

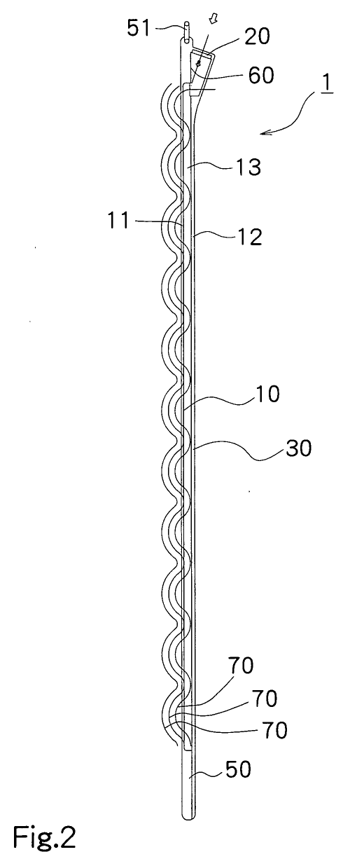

The present invention is described in detail with referent to the drawings. FIG. 1 shows a plan view of the cosmetic device 1 according to the present invention. FIG. 2 is an A-A cross section of FIG. 1. The present invention should not be limited to these embodiments.

The cosmetic device 1 compresses a fluid-storing portion 10, four ultrasonic transducers 20a, 20b, 20c and 20d (hereinafter referred to as “ultrasonic transducers 20” if these are referred to generically) and a surface-wave-generating material 60.

As shown in FIG. 1 and FIG. 2, the ultrasonic transducers 20 are supported by the surface-wave-generating material 60. Additionally, the surface-wave-generating material 60 is disposed so as to contact an edge of the fluid-storing portion 10. By this construction, when vibration generated by the ultrasonic transducers 20 is propagated to the surface-wave-generating material 60 as described later, the vibration is propagated to the fluid-storing portion 10 as surface waves.

Additionally, the cosmetic device 1 compresses a rubber vibration-prevention layer 30 along a backside surface 12 of the fluid-storing portion 10. By this vibration-prevention layer, vibration of a surface on the opposite side of the body-contacting surface 11 of the cosmetic device 1 is prevented, and at the same time, the body-contacting surface 11 of the cosmetic device 1 can be vibrated efficiently. For this vibration-prevention layer, any material which can absorb an impact given by the vibration can be used in addition to rubber.

Additionally, as shown in FIG. 1 and FIG. 2, the cosmetic device 1 compresses the fluid-storing portion 10, ultrasonic transducers 20 and a belt 50 which supports the surface-wave-generating material 50 from the reverse side of the body-contacting surface 11 in the fluid-storing portion 10. At one end of the belt 50, a ring material 51 used for attaching the belt to a part of the body along with the fluid-storing portion 10, the ultrasonic transducers 20, and the surface-wave-generating material 60 is provided. With this ring material 51, after the cosmetic device 1 is placed with the body-contacting surface 11 of the fluid-storing portion 10 facing the body, attaching the cosmetic device 1 around the body becomes possible by winding an end of the belt 50 around the ring material 51 and fixing it with a flat fastener not shown.

The fluid-storing portion 10 is formed using, e.g. a soft vinyl chloride resin. The fluid-storing portion 10 comprises a pouched material, on whose surface the body contact surface 11 and the backside surface 12 are formed. The body-contacting surface 11 is planate, which allows contacting the body. Additionally, at the edge of the backside surface 12, the surface-wave-generating material 60 is installed.

Furthermore, inside the fluid-storing portion 10, a fluid 13 is housed. With this construction, it becomes possible to contact the body-contacting surface 11 with the body in accordance with a shape of the body. Additionally, in this specification, gels that sol solidifies to a jelly, creams, etc. are all referred to as fluids.

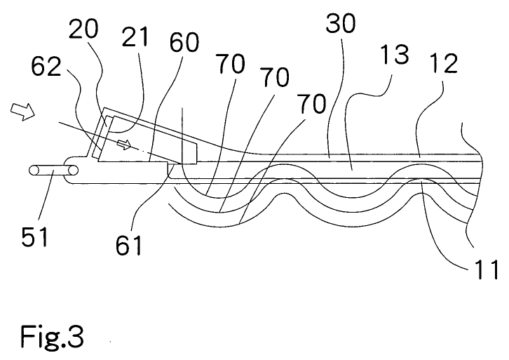

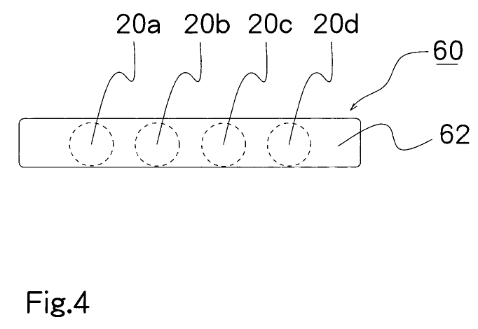

FIG. 3 is an enlarged cross section showing a peripheral portion of the surface-wave-generating material 60 in the cosmetic device 1 according to the present invention. FIG. 4 is a front view showing a position in which the surface-wave-generating material 60 in the cosmetic device 1 according to the present invention supports the ultrasonic transducers 20.

The ultrasonic transducers 20, as shown in FIG. 3, has a given angle of gradient with the body-contacting surface 11 of the fluid-storing portion 10 and is supported by the surface-wave-generating material 60 in a manner that the sliding surface 21 of the ultrasonic transducers 20 is positioned facing the fluid-storing portion 10. Consequently, surface waves 70 propagated to the fluid-storing portion 10 via the surface-wave-generating material 60 are propagated parallel to the body-contacting surface 11 of the fluid-storing portion 10. Thus, it becomes possible to propagate the surface waves 70 to the entire surface of the fluid-storing portion 10.

Additionally, as shown in FIG. 4, four ultrasonic transducers 20a, 20b, 20c and 20d are disposed side by side and parallel to a contacting surface (incidence plane) 61 in the surface-wave-generating material 50. Consequently, it becomes possible to give ultrasonic vibration to the entire surface of the contacting surface 61 in the surface-wave-generating material 60.

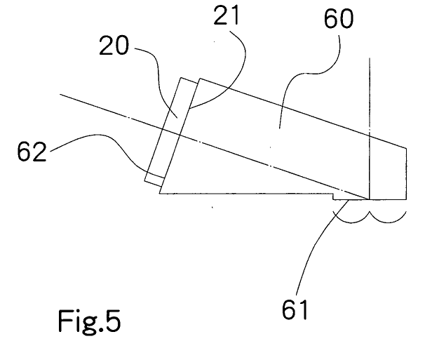

FIG. 5 is a lateral view of the ultra transducers 20 and the surface-wave-generating material 60 in the cosmetic device 1 according to the present invention.

The surface-wave-generating material 60, as shown in FIG. 5, has the contacting surface 61 which contacts the backside surface 12 of the fluid-storing portion 10 and a supporting surface 62 which supports the ultrasonic transducers 20. The contacting surface 61 and the supporting surface 62 have a given angle. Vibration generated by the ultrasonic transducers 20 proceeds inside the surface-wave-generating material 60 as longitudinal waves. These longitudinal waves change to transversal waves by colliding with the contacting surface 61, and are propagated along the fluid-storing portion 10 as surface waves 70. At this time, the center of the contacting surface 61 and the normal line from nearly the center of the ultrasonic transducers cross. By this, it becomes possible to effectively propagate the surface waves 70 to the fluid-storing portion 10.

As mentioned above, on the backside surface 12 of the fluid-storing portion 10, a rubber vibration-prevention layer 30 is provided. By this vibration-prevention layer, vibration of the backside surface of the body-contacting surface 11 of the cosmetic device 1 is prevented, and at the same time, it becomes possible to vibrate the body-contacting surface 11 of the cosmetic device 1 efficiently using the above-mentioned surface waves 70.

Furthermore, this contacting surface 61 is constructed to be a convex planar surface. With this construction, only vibration generated at the contacting surface 61 is propagated to the fluid-storing portion 10. Consequently, it becomes difficult for other surface waves having different phases to interfere the surface waves propagated to the fluid-storing portion, enabling the surface waves 70 to be further efficiently propagated to the fluid-storing portion 10.

As a material for the surface-wave-generating material 60, acrylic resin is one example; various materials including metals such as iron and aluminum, which can propagate ultrasonic vibration, can be used.

To obtain a propagation depth of the surface waves 70 of approximately 35 mm against the fluid-storing portion 10, which is effective to get cosmetic effects, setting a frequency of the ultrasonic transducer 20 at approximately 80 KHz is preferable.

The cosmetic device 1 according to the above-mentioned embodiment compresses the belt 50 which supports the fluid-storing portion 10 and the ultrasonic transducers 20 from the reverse side of the body-contacting surface 11 in the fluid-storing portion 10. The belt 50 can be omitted.

Additionally, the cosmetic device 1 according to the above-mentioned embodiment compresses four ultrasonic transducers 20a, 20b, 20c and 20d. The number of the ultrasonic transducers is not limited to four and can be one or more.

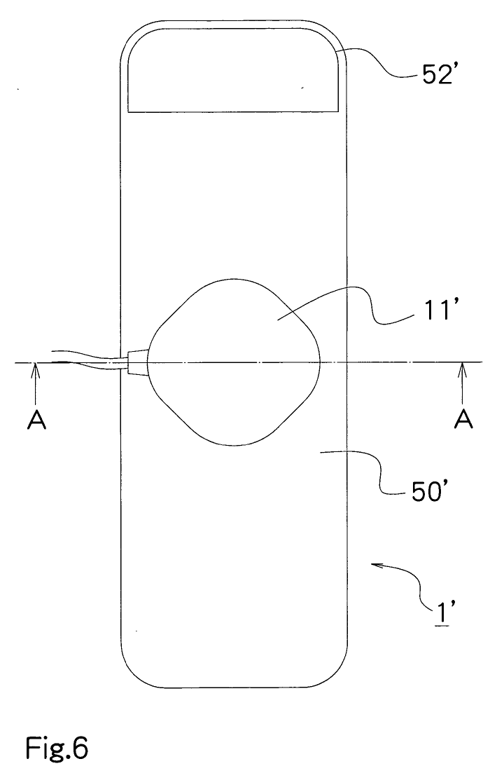

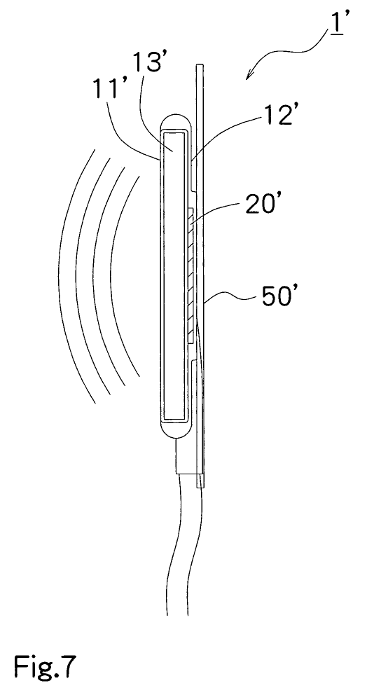

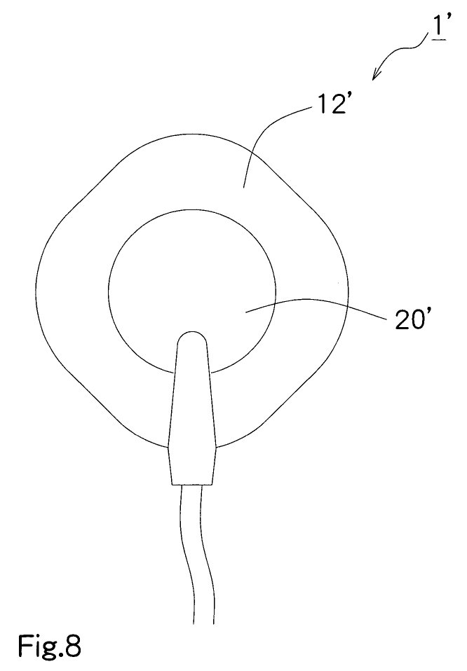

In another embodiment of the present invention, the transducers can be disposed differently to use vertical propagation of ultrasonic waves. This type of embodiment is described in detail with referent to the drawings. FIG. 6 shows a front view of the cosmetic device 1′ according to the present invention. FIG. 7 is a longitudinal cross section showing an A-A cross section in FIG. 6. FIG. 8 is a backside view of a cosmetic device 1′ according to the present invention with the belt 50′ removed.

The cosmetic device 1′ compresses a fluid-storing portion 10′, ultrasonic transducers 20′. The fluid-storing portion 10′ comprises a pouched material on whose surface a contact surface is formed. This contact surface is planate so as to be able to contact the body. The ultrasonic transducers are disposed on a surface 12′ on the reverse side of the contact surface 11′ in the fluid-storing portion 10′.

Additionally, the cosmetic device 1′ compresses a belt 50 which supports the fluid-storing portion 10′ and the ultrasonic transducers 20′ from the reverse side of the contact surface 11′ in the fluid-storing portion 10′. At one end of the belt 50′, a planar fastener 52′ used for attaching the belt 50′ to a part of the body along with the fluid-storing portion 10′ and the ultrasonic transducers 20′ is provided. With this fastener provided, after the cosmetic device 1 is placed with the contact surface 11′ of the fluid-storing portion 10′ facing the body, the cosmetic device 1′ can be attached around the body by fixing the end of the belt 50′ using the planar fastener 52′.

The fluid-storing portion 10′ is formed using, e.g. a soft vinyl chloride resin. Inside the fluid-storing portion 10′, a fluid 13′ is housed. This construction enables the contact surface 11′ to contact a part of the body in accordance with a body shape. Additionally, in this specification, high-viscosity liquids, semifluids, or gels that sol solidifies to a jelly, creams and regular liquids are all referred to as fluids.

The cosmetic device 1 according to the above-mentioned second embodiment comprises the belt 50′ which supports the fluid-storing portion 10′ and the ultrasonic transducers 20′ from the reverse side of the body contact are 11′ in the fluid-storing portion 10′. The belt 50′ can be omitted.

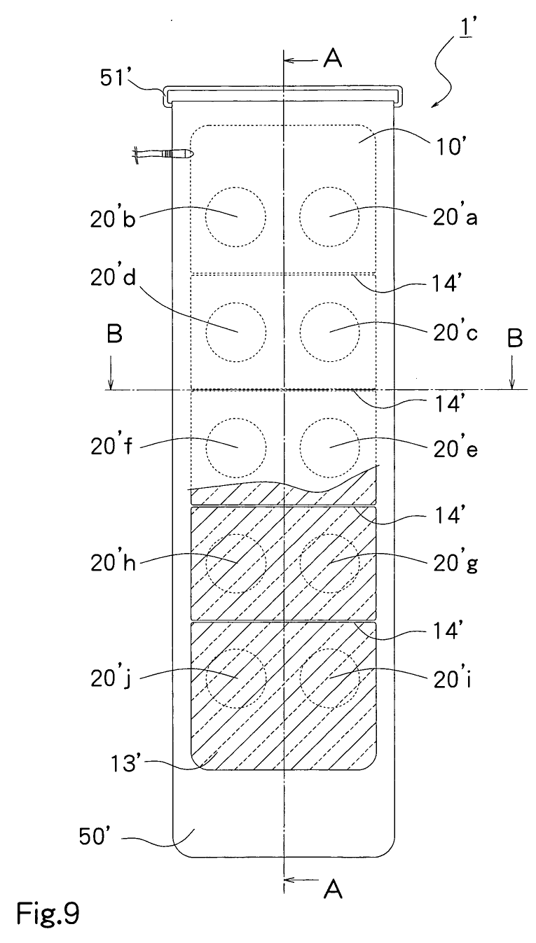

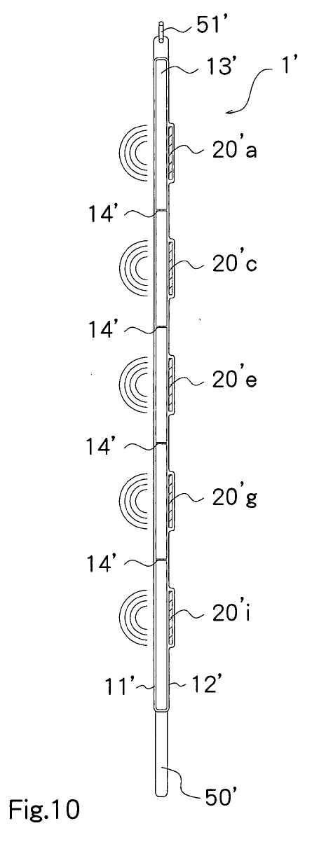

Another embodiment of the present invention is described with referent to the drawings. FIG. 9 is an explanation drawing of the cosmetic device 1′ according to the third embodiment of the present invention. FIG. 10 is a longitudinal cross section showing an A-A cross section in FIG. 9.

The cosmetic device 1′ compresses a fluid-storing portion 10′, ten ultrasonic transducers 20′a, 20′b, 20′c, 20′d, 20′e, 20′f, 20′h, 20′i and 20′j (hereinafter referred to as “ultrasonic transducers 20′” if these are referred to generically). The fluid-storing portion 10′ comprises a pouched material on whose surface a contact surface which can contact the body is formed. This contact surface is planate so as to be able to contact the body. The ultrasonic transducers 20′ are disposed on the surface 12′ on the reverse side of the contact surface 11′ in the fluid-storing portion 10′.

Additionally, the cosmetic device 1′ compresses a belt 50′ which supports the fluid-storing portion 10′ and ultrasonic transducers 20′ from the reverse side of the body contact surface 11′ in the fluid-storing portion 10′. At one end of the belt 50′, a ring material 51′ used for attaching the belt 50′ to a part of the body along with the fluid-storing portion 10′ and the ultrasonic transducers 20′ is provided. With this ring material 51′ provided, after the cosmetic device 1′ is placed with the contact surface 11′ of the fluid-storing portion 10′ facing the body, attaching the cosmetic device 1′ around the body becomes possible by winding an end portion of the belt 50′ around the ring material 51′ and fixing it by a flat fastener not shown.

The fluid-storing portion 10′ is formed using, e.g. a soft vinyl chloride resin. Inside the fluid-storing portion 10′, a fluid 13′ is housed. This construction enables the contact surface 11′ to contact a part of the body in accordance with a body shape.

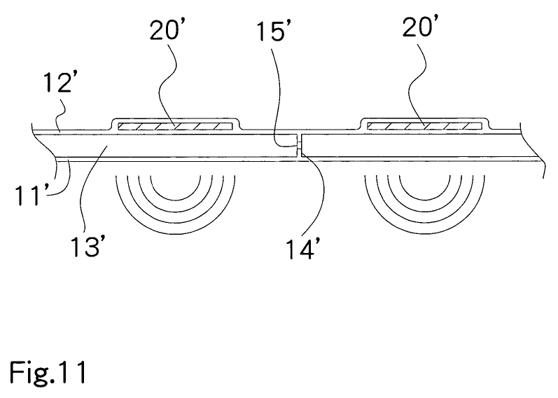

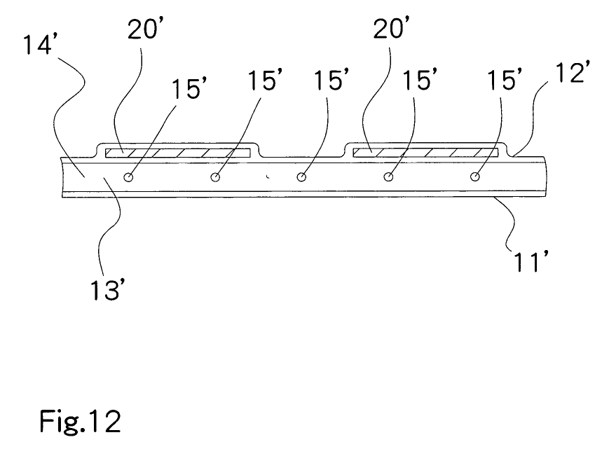

FIG. 11 is a longitudinal cross section showing the relevant part of the fluid-storing portion 10′ of the cosmetic device 1′ according to the third embodiment of the present invention. FIG. 12 is a longitudinal cross section showing a B-B cross section in FIG. 9.

As shown in FIG. 11 and FIG. 12, the fluid-storing portion 10′ compresses partition-walls 14′ dividing a fluid housed inside the fluid-storing portion into five surfaces. In respective surfaces divided by the partition-walls 14′, two ultrasonic transducers each are arranged. With this construction, it becomes possible to stabilize the fluid housed inside the surfaces divided by the partition-walls 14′.

Additionally, as shown in FIG. 11 and FIG. 12, multiple pores 15′ through which the fluid 13′ can pass are formed in the partition-walls 14′. With this construction, it becomes possible that the fluid 13′ moves inside the fluid-storing portion according to shape change in the cosmetic device 1′ due to concavity and convexity of the body and the cosmetic device 1′ is contacted with the body.

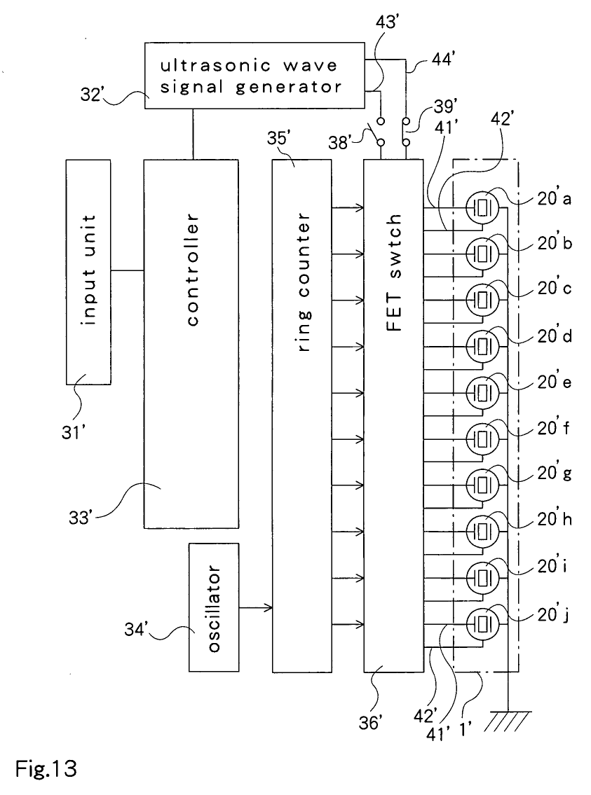

FIG. 13 is a block diagram showing a main electrical configuration of the cosmetic device 1′ according to the third embodiment of the present invention.

The cosmetic device 1 compresses an ultrasonic-wave-generating portion 32′ which generates ultrasonic signals, and an input portion 31′ connected to a controller 33′ which functions as a control unit for the ultrasonic-wave-generating portion 32′.

Additionally, this cosmetic device 1 compresses a FET switch 36′ and a oscillator 34′ which feeds clock signals of approximately 5 Hz indicating a switching timing to a ring counter 35′ used for switching the FET switch 36′.

The ultrasonic-wave-generating portion 32′ generates two types of ultrasonic signals with 3 MHz frequency and 2 MHz frequency. Ultrasonic waves with 3 MHz ultrasonic frequency reaches the FET switch 36′ via wiring 43′ and a switch 38′, and is fed to five ultrasonic transducers 20′a, 20′c, 20′e, 20′g and 20′i via wiring 41 from the FET switch 36′. Ultrasonic waves with 2 MHz ultrasonic frequency reaches the FET switch 36′ via wiring 45′ and a switch 49′, and is fed to five ultrasonic transducers 20′b, 20′d, 20′f, 20′h and 20′j via the wiring 41′ from the FET switch 36′.

In the cosmetic device 1′ having the electrical configuration shown in FIG. 13, the ultrasonic-wave-generating portion 32′ and the ultrasonic transducers 20′ are connected sequentially by the action of the ring counter 35′ and the FET switch 36′ in a timely manner described later and each of ultrasonic transducers 20′ vibrates sequentially. At this time, the switch 38′ is closed and the switch 39′ is opened when the ultrasonic-wave-generating portion 32′ and the ultrasonic transducers 20′a, 20′c, 20′e, 20′g and 20′i are connected. When the ultrasonic-wave-generating portion 32′ and the ultrasonic transducers 20′b, 20′d, 20′f, 20′h and 20′j are connected, the switch 39′ is closed and the switch 38′ is opened.

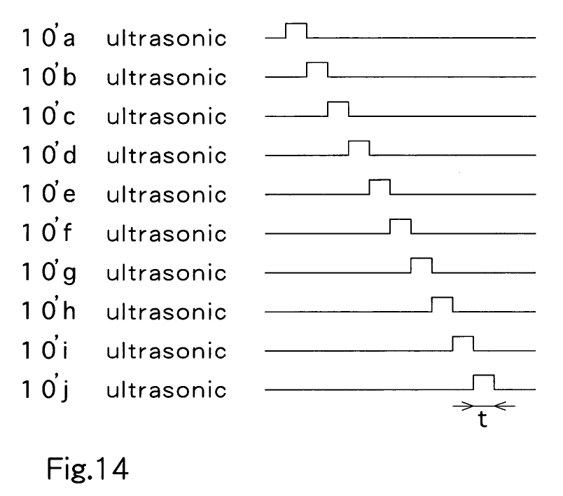

FIG. 14 is a time chart showing timing according to which respective ultrasonic transducers of the cosmetic device 1′ according to the third embodiment of the present invention vibrate.

As shown in FIG. 14, the ultrasonic transducer 20′a first vibrates for time t, which is 0.4 seconds when a frequency of a clock signal given to the ring counter 35′ from the oscillator 34′ is 2.5 Hz. As soon as the vibration of the ultrasonic transducer 20′a stops, the ultrasonic transducer 20′b vibrates. By repeating this sequence, 10 ultrasonic transducers 20′a, 20′b, 20′c, 20′d, 20′e, 20′f, 20′h, 20′i and 20′j vibrate in this order.

Consequently, even in a configuration in which this cosmetic device contacts the skin at all times, excessive stimulation is not applied to the skin.

In the above-mentioned embodiment, ultrasonic vibration is given in the order of the ultrasonic transducer 20′a, the ultrasonic transducer 20′b, the ultrasonic transducer 20′c, the ultrasonic transducer 20′d, the ultrasonic transducer 20′e, the ultrasonic transducer 20′f, the ultrasonic transducer 20′g, the ultrasonic transducer 20′h, the ultrasonic transducer 20′i, and the ultrasonic transducer 20′j. Ultrasonic vibration can be given in the order of the ultrasonic transducer 20′a, the ultrasonic transducer 20′b, the ultrasonic transducer 20′d, the ultrasonic transducer 20′f, the ultrasonic transducer 20′h, the ultrasonic transducer 20′j, the ultrasonic transducer 20′i, the ultrasonic transducer 20′g, the ultrasonic transducer 20′e, and the ultrasonic transducer 20′c.

Additionally, ultrasonic vibration is given to ten ultrasonic transducers 20′a, 20′b, 20′c, 20′d, 20′e, 20′f, 20′h, 20′i and 20′j randomly using a random number, etc.

Furthermore, although in the above-mentioned embodiment, a configuration in which ultrasonic vibration is given to a single ultrasonic transducer of ten ultrasonic transducers 20′a, 20′b, 20′c, 20′d, 20′e, 20′f, 20′h, 20′i and 20j sequentially is used, a configuration in which ultrasonic vibration can be given to multiple ultrasonic transducers simultaneously can also be used. For example, ultrasonic vibration is given first to the ultrasonic transducer 20′a, the ultrasonic transducer 20′b, and the ultrasonic transducer 20′c for time t; subsequently to the ultrasonic transducer 20′g, the ultrasonic transducer 20′h, and the ultrasonic transducer 20′i for time t; then to the ultrasonic transducer 20′j, the ultrasonic transducer 20′a, and the ultrasonic transducer 20′b; thereafter, a sequence of giving ultrasonic vibration to three ultrasonic transducers at a time is repeated.

1. A cosmetic device for improving skin conditions comprising:
a fluid-storing portion fluid-tightly storing a fluid therein comprised of a thin material, on a surface of which portion a planar contact surface adapted to contact a skin of the body is formed, said fluid-storing portion being divided into multiple compartments by isolation walls having holes through which the fluid passes; and
multiple ultrasonic transducers disposed on the fluid-storing portion opposite to the planar contact surface to propagate ultrasonic waves through the fluid to the skin.

2. The cosmetic device according to claim 1, wherein the ultrasonic transducers are disposed on the respective compartments.

3. The cosmetic device according to claim 1, wherein the fluid is a gel or cream which propagates ultrasonic waves.

4. The cosmetic device according to claim 1, further comprising a controller which transmits ultrasonic wave signals to each transducer in sequence.

5. The cosmetic device according to claim 1, wherein each transducer is capable of emitting ultrasonic waves at a frequency of about 500 kHz to about 10 MHz.

6. The cosmetic device according to claim 1, further comprising a vibration stop layer disposed on a side opposite to the planar contact surface of the fluid-storing portion.

7. A cosmetic device for improving skin conditions comprising:
a fluid-storing portion fluid-tightly storing a fluid therein comprised of a thin material, on a surface of which portion a planar contact surface adapted to contact a skin of the body is formed; and
at least one ultrasonic transducer disposed at one longitudinal end of the fluid-storing portion at an acute angle formed by an axis of the transducer and an incidence plane of the fluid at the longitudinal end, to generate surface waves at the longitudinal end and to propagate transversal waves through the fluid to the skin.

8. The cosmetic device according to claim 7, wherein the axis of the transducer is positioned at a middle point of the incidence plane of the fluid in a propagation direction.

9. The cosmetic device according to claim 7, wherein the transducer and the fluid-storing portion are configured to provide a propagation depth of about 35 mm in the fluid.

10. The cosmetic device according to claim 7, wherein the transducer is capable of emitting ultrasonic waves at a frequency of about 40 kHz to about 1 MHz.

11. The cosmetic device according to claim 7, further comprising a vibration stop layer disposed on a side opposite to the planar contact surface of the fluid-storing portion.

12. A cosmetic device for a skin comprising:
a fluid-storing portion storing a fluid therein and constituted by a soft pouched material, on a surface of which portion a body-contacting planar surface which can contact the body is formed;
at least one ultrasonic transducer having a given angle of gradient with the body-contacting surface of said fluid-storing portion, wherein an oscillating surface of said transducer is disposed facing said fluid-storing portion; and
a surface-wave-generating material supporting said ultrasonic transducers and having a contacting surface which contacts the edge of said fluid-storing portion, wherein said contacting surface is disposed to cross the normal line from nearly the center of said ultrasonic transducer.

13. The cosmetic device according to claim 12, wherein the center portion of the contacting surface of said surface-wave-generating material and the normal line from nearly the center of said ultrasonic transducers are crossed.

14. The cosmetic device according to claim 12, wherein the contacting surface of said surface-wave-generating material is a convex planar surface.

15. The cosmetic device according to claim 12, further comprising a supporting material which supports said fluid-storing portion and said ultrasonic transducer from the reverse side of said body-contacting surface in said fluid-storing portion, wherein said supporting material comprises a fastening material to be used to attach said supporting material to a part of the body along with said fluid-storing portion and said ultrasonic transducer.

16. A cosmetic device for a skin comprising:
a fluid-storing portion storing a fluid therein and comprising a soft pouched material, on a surface of which portion a planar contact surface which can contact the body is formed;
partition-walls dividing a fluid stored inside said fluid-storing portion into multiple compartments, wherein multiple pores through which said fluid can pass are formed in said partition-walls; and
multiple ultrasonic transducers, which are disposed on a surface on the reverse side of said contact surface.

17. The cosmetic device according to claim 16, further comprising an ultrasonic-transducer drive mechanism which vibrates said multiple ultrasonic transducers sequentially.

18. The cosmetic device according to claims 16, further comprising a supporting material which supports said fluid-storing portion and said ultrasonic transducer from the reverse side of said contact surface in said fluid-storing portion and wherein said supporting material comprises a fastening material which is used for attaching the supporting material to a part of the body along with said fluid-storing portion and said ultrasonic transducer.
